(19) United States
(12) Patent Application Publication
(10) Pub. No.: US 2002/0142129 A1
(43) Pub. Date: Oct. 3, 2002

(54) Automotive head impact protection

(75) Inventor: Mansoor Arif Chaudhry, Windsor (CA)

Correspondence Address: Russell R. Stolle, Hustman Corporation, P.O. Box 15730, Austin, TX, 78761, US

(73) Assignee: Hutsman Corporation, Salt Lake City, UT (US)

(21) Appl. No.: 09/921,405

(22) Filed: Aug. 2, 2001

Related U.S. Application Data
(60) Provisional application No. 60/270,227, filed on Feb. 21, 2001.

(51) Int. Cl. B32B 3/10

(52) U.S. Cl. 428/131; 428/120

(57) ABSTRACT

Provided herein are headliners for use in motorized vehicles. The headliners are of such construction that head impact encountered during a collision is greatly reduced over headliners of prior art. A headliner according to the invention comprises a substantially-planar first base portion having an upper surface and a lower surface, and a plurality of absorption projections disposed on said upper surface of said base portion. The absorption projections each are shaped in the form of a geometric solid having an axis. The absorption projections include a second base portion and a topmost portion, and the absorption projections extend from the upper surface such that their axes are oriented substantially perpendicularly to the plane of the base portion.

### FIELD OF THE INVENTION

This invention relates to headliners for use in the interiors of motorized vehicles such as automobiles and trucks. More particularly, it relates to headliners that include shaped projections that extend from a flat surface and are able to absorb and disperse the energy from a collision. The headliners according to the invention are readily adaptable to fit all types of vehicle contours and are useful on roof portions and support beams, and other areas where a passenger's body part may contact a part of the vehicle during the course of a collision.

### BACKGROUND OF THE INVENTION

Headliners for motor vehicles are mounted inside the passenger compartment and against the sheet metal roof of the vehicle to provide an aesthetic covering for the sheet metal. Historically, headliners have been constructed of a single layer. However, more recently, headliners comprising multiple layers laminated together have been proposed in response to increased requirements of safety measures for vehicle passengers in the event of an impact. Federal regulations have become increasingly stringent, especially regarding energy absorption of passenger head impact. For example, the Laboratory Test Procedure for FMVSS 201 requires that future passenger cars and other light vehicles achieve a head impact energy absorption performance requirements HIC(d) which shall not exceed a value of 1000, when calculated in accordance with the following formula: HIC(d)=0.75446 (Free Motion Headform HIC)+164 HIC, wherein HIC is calculated by the following formula:

$$HIC = {[ \frac{1}{{t}_{2} - {t}_{1}} {\int }_{{t}_{1}}^{{t}_{2}} a ⅆ t ]}^{2.5} ( {t}_{2 } - {t}_{1} )$$

in which t₁ and t₂ are any two points in time during the impact event separated by no more than a 36 millisecond time period, and a is the resultant acceleration at the head center of gravity (c.g.).

These new standards require that the structure above the vehicle beltline (bottom of vehicle glass) subject to occupant head impact be modified to meet these standards. Many materials have been evaluated for impact energy absorption, but have been found to be too bulky and/or expensive for use in the confines of a modern vehicle interior where maximizing available open space is desirable. An additional criterion is the retention of a high level of sound absorption to provide a quiet environment inside a motor vehicle.

A wide variety of materials have been employed in vehicles for minimizing head injuries in the event of an accident. Previously, a variety of open and closed cell foam materials have been employed for areas such as the instrument panel. In order to provide head impact absorption in contemporary vehicles, padded visors have been employed as shown in U.S. Pat. No. 4,958,878 for protecting the occupants in the front windshield area. In more recent years, headliners for vehicles have been integrally molded and have a thicknesses which vary depending upon the area of the headliner, where the thickness of headliners is thicker in areas where absorption and diffusion of impact energy may be important. With such increased thickness, however, the cost of manufacturing the headliner through a molding process increases, as does the complexity of the size and shapes of the molds employed, thus complicating the manufacturing process and increasing the need for quality control measures. Further, modem vehicles do not allow space for a significant additional conventional padding or cushioning materials in view of the trend towards more compact interior designs and in some cases highly angled windshields.

U.S. Pat. No. 4,131,702, for example, describes a self-supporting molded headliner formed of a layered composite arrangement of polyethylene foam panels laminated on both sides to a reinforcing layer of rigid paperboard. Similarly, U.S. Pat. No. 5,503,903 depicts a headliner including front and back sheets of wood fibers and polypropylene laminated with an intermediate corrugated sheet. U.S. Pat. No. 4,020,207 depicts a multiple-layer structure comprising two sheets of polyethylene foam bonded with a reinforcing polymer-containing layer.

U.S. Pat. No. 5,879,802 teaches a vehicle panel material comprising a mixture of recycled, reground thermo-formable material and reprocessed headliner material which includes fibrous bats with polyester fibers, glass fibers and a thermo-setting resin. The method of manufacturing such material includes the steps of shredding thermo-formable material into strips; shredding headliner material comprising thermo-formable fibrous bats, glass fibers and thermo-setting resin; mixing and carding the thermo-formable material and headliner material into a mat; heating the mat to at least partially melt the thermo-formable material; and shaping the mat into a vehicle panel.

U.S. Pat. No. 5,884,962 discloses an impact absorption member comprising a sheet of crushable material having curvilinear projections having a width, height, length and spacing selected for different impact absorption characteristics. In a preferred embodiment of the invention, the projections are sinusoidal, and the material comprises a mixture of recycled, reground thermo-formable material and reprocessed fibrous bats including polyester fibers, glass fibers, and a thermo-setting resin. In the preferred embodiment of the invention, the member constitutes an elongated arch-shaped base having integrally superimposed thereon the curvilinear projections.

U.S. Pat. No. 6,036,227 sets forth an energy absorption material for covering a rigid vehicle support surface to provide impact protection for a vehicle occupant's head comprising a sheet of material formed into a waveform comprising a plurality of regular corrugations which have identical crests and valleys connected by inclined sidewalls. The material thickness of the crests and valleys is the same and thicker than that of the sidewall material. The crests and valleys are curved such that the inside radius of each of the crests is smaller than the inside radius of each of the valleys, so that the sidewalls adjacent a valley are laterally closer than the sidewalls adjacent a crest. The corrugations have a pitch equal to their height. This construction provides a deformation mode of the material in which the crests and valleys deform by bending and the sidewalls deform by buckling. The material can contain a plurality of perforations, covering 7%-15% of the area for sound absorption.

U.S. Pat. No. 6,070,902 teaches a vehicle interior headliner system useful in a vehicle having side windows and a roof panel. The headliner system includes a headliner attachable to the roof panel by a self-locating attachment system configured for blind attachment of the headliner to the roof panel. At least one inflatable bladder is secured to the headliner by the self-locating attachment system for deployment along the side windows. At least one inflator assembly is secured to the headliner for inflating the bladder. The self-locating attachment system includes a conical retainer and a floating fastener for blind attachment in a variety of applications.

U.S. Pat. No. 6,120,090 sets forth a headliner for motor vehicles which includes first and second sheets of material in juxtaposition to each other and adapted for positioning in a mold having two mold portions. The material of at least one of the sheets is fluid deformable with respect to another of the sheets, and is attachable to the material of the other of the sheets by the mold portions at sufficient locations to outline a potential duct between the sheets. The potential duct is adapted to receive fluid between the sheets for forming an actual duct. When fluid is received between the sheets, the material of the at least one sheet is deformed with respect to the material of the other of the sheets to define the actual duct. In one embodiment of the headliner, at least one head impact block is disposed in the duct. The headliner may also include at least one substantially air-impermeable layer disposed within the duct and attached to at least one of the first and second sheets. The layer preferably includes a polymer powder.

All of the foregoing U.S. patents are herein incorporated in their entirety by reference thereto.

Another known headliner construction includes top and bottom sheets attached together to form a duct in the rear portion of the headliner. The top sheet includes a corrugated cardboard layer sandwiched between two perforated polymer layers that allow moisture to pass therethrough. Furthermore, the top sheet is preformed by compression molding before being attached to the bottom sheet. Since space is limited, it is desirable to develop a material that can meet these stringent energy absorption standards and still provide sufficient sound isolation characteristics.

### SUMMARY OF THE INVENTION

The present invention provides a construct useful as a headliner in a motorized vehicle that includes a substantially planar first base portion having an upper surface and a lower surface, and a plurality of absorption projections disposed on the upper surface of the base portion. The absorption projections each are shaped in the form of a geometric solid having an axis. The absorption projections may include a second base portion and a topmost portion, and the absorption projections extend from the upper surface such that their axes are oriented substantially perpendicularly to the plane of the base portion, The absorption projections include a hollow interior portion in a preferred form of the invention. Although the invention is described in terms of automotive headliners, the constructs of the invention are anticipated as being useful in other articles of manufacture which are designed for human head contact, including without limitation, motorcycle helmets, aircraft helmets, and sports helmets.

Another form of the present invention is a method of molding an automobile headliner that includes a substantially planar first base portion having an upper surface and a lower surface, and a plurality of absorption projections disposed on the upper surface of said base portion. The absorption projections each are shaped in the form of a geometric solid having an axis. The absorption projections include a second base portion and a topmost portion, and the absorption projections extend from the upper surface such that their axes are oriented substantially perpendicularly to the plane of the base portion, The absorption projections include a hollow interior portion in a preferred form of the invention.

### BRIEF DESCRIPTION OF THE DRAWINGS

The above and further advantages of the invention may be better understood by referring to the following detailed description in conjunction with the accompanying drawings in which corresponding numerals in the different figures refer to the corresponding parts in which:

FIG. 1 is a perspective view of a section of a headliner construct according to one form of the invention;

FIG. 2a is a top view of a section of a headliner construct according to one form of the invention;

FIG. 2b is a side view of a section of a headliner construct according to one form of the invention;

FIG. 2c is a end view of a section of a headliner construct according to one form of the invention;

FIG. 2d is a top view of a section of a headliner construct according to an alternate form of the invention;

FIG. 2e is an underside view of a section of a headliner construct according to one form of the invention;

FIG. 3 is a perspective view of a section of a headliner construct according to an alternate form of the invention;

FIG. 4a is a top view of a section of a headliner construct according to an alternate form of the invention;

FIG. 4b is an end view of a section of a headliner construct according to an alternate form of the invention;

FIG. 4c is a section A-A view of a section of a headliner construct according to an alternate form of the invention;

FIG. 4d is an underside view of a section of a headliner construct according to an alternate form of the invention.

FIG. 5a is a perspective view of a section of a headliner construct according to an alternate form of the invention;

FIG. 5b is a top view of a section of a headliner construct according to an alternate form of the invention;

FIG. 5c is a side view of a section of a headliner construct according to one form of the invention;

FIG. 5d is a end view of a section of a headliner construct according to one form of the invention; and

FIG. 6 is a graph depicting the performance of an object in accordance with the present invention.

### DETAILED DESCRIPTION OF THE INVENTION

While the making and using of various embodiments of the present invention are discussed herein in terms of an automobile headliner and a method for making one, it should be appreciated that the present invention provides many applicable inventive concepts that can be embodied in a wide variety of specific contexts. The specific embodiments discussed herein are merely illustrative of specific ways to make and use the invention and are not meant to limit the scope of the invention in any manner.

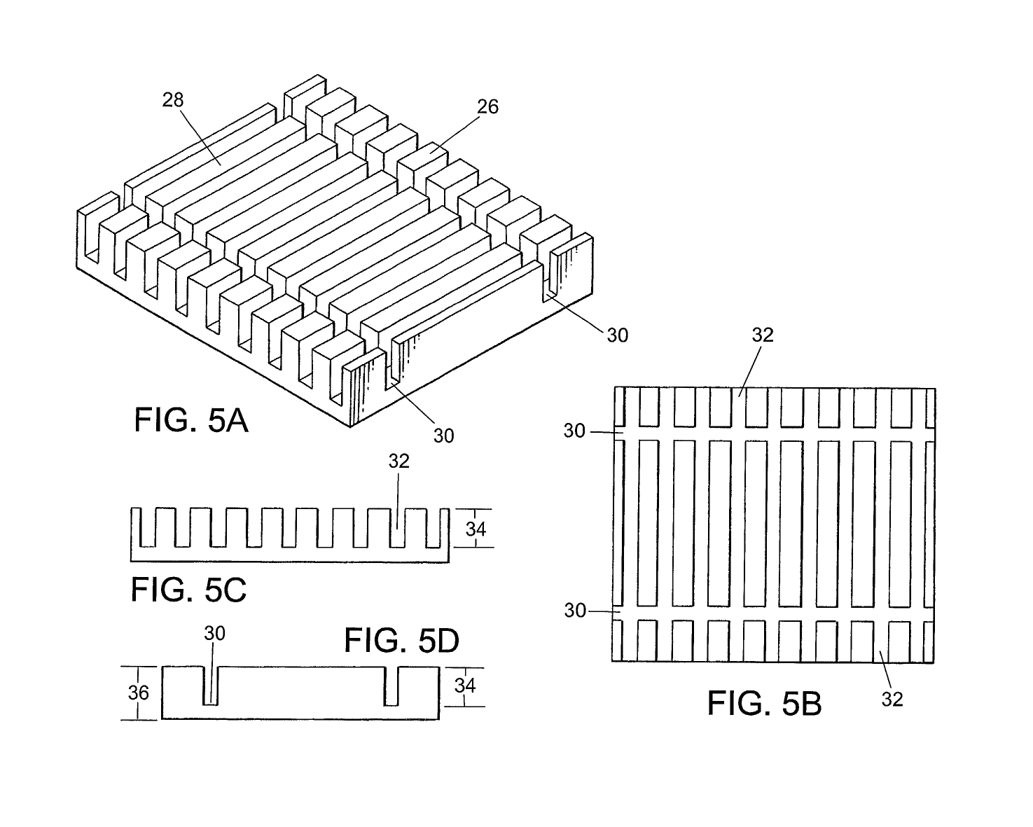

Although the embodiments herein depicted in the various drawings show a construct according to the invention having absorption projections of uniform shape and dimension, the subject matter of the present invention contemplates headliner constructs comprising an assortment of absorption projections having different geometrical shapes. For example, a headliner construct according to the invention may include a row of truncated cones adjacent to a row of truncated pyramids. Alternatively, headliner constructs according to the present invention may include a row of rectangular solids adjacent to a row of truncated pyramids or a row of truncated cones. The various absorption projections selected may be present in a mixed array or present in a regularly repeating pattern. One non-delimitive example is shown in FIG. 5 in which a preferred embodiment of the invention is depicted as a headliner construct comprising two differently sized rectangular solids having different length dimensions arranged in a regular array.

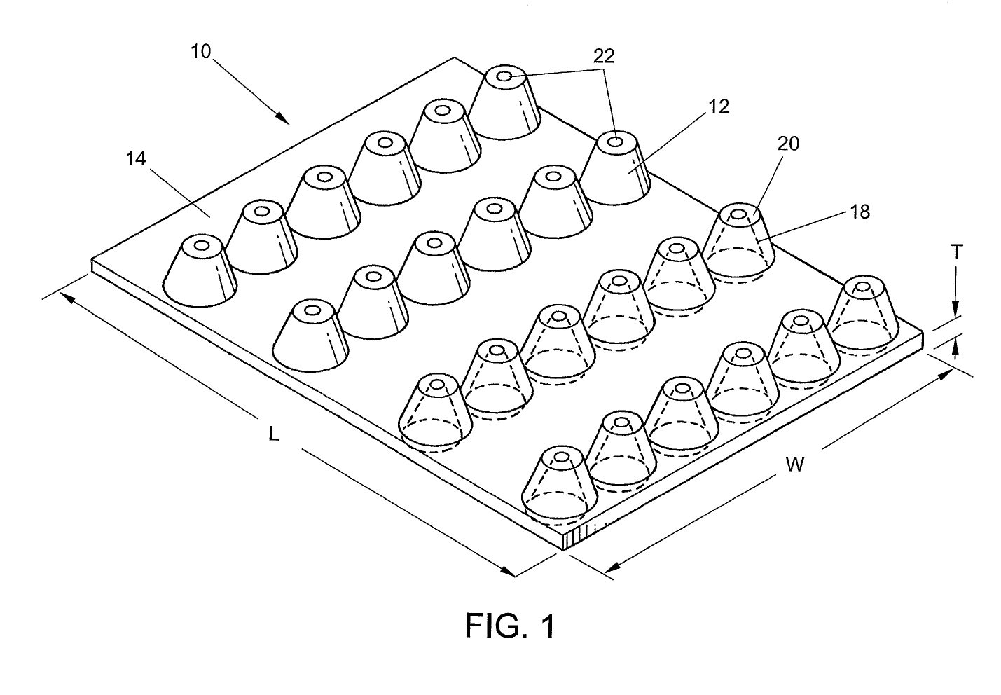

Referring to the drawings and initially to FIG. 1 there is shown a section of a headliner construct 10 according to one form of the invention. Such a construct comprises a base portion 14, which exists substantially in the shape of a planar sheet and can be thought of for purposes of defining the present invention as having a length dimension L, a width dimension W, and a thickness dimension T, although it may be rare that in actual practice that a rectangular construct would be employed since the head space in the interior of a motor vehicle is not exactly rectangular; however, it is nevertheless advantageous for defining the invention to consider a rectangular section of the disclosed construct.

In accordance with the invention, the base portion includes one or more absorption projections 12 which extend upwardly from the plane of the base portion. It is preferred that the projections are shaped in the form of geometric solids, such as cones, conical sections, pyramids, truncated pyramids, rectangular solids, rectangles, cubes, spheres, spheroids, ellipses, truncated ellipses, rhombohedral solids, truncated rhombohedral solids, etc. In one form of the invention, it is preferred that the absorption projections comprise a hollow interior portion 18 which assists in the absorption and dispersal of the energy from an impact, and such feature is conveniently achieved in a preferred manufacturing process of the constructs of the invention described elsewhere herein.

In the cases where it is desired to employ a truncated geometric solid, such as a truncated pyramid or truncated cone, as shown in FIG. 1, such truncated solid will preferably comprise a flat top portion 20, and a hole 22 as shown in FIG. 1, which hole extends through the entire construct, including the base portion 14.

One variable in a headliner construct according to the invention is the size of the hole 22 at the top flat surface portion 20. It is preferred that when such hole is circular as in the cases where a truncated cone or cylindrically shaped absorption projection is selected, the diameter of the hole is preferably any value in the range of between about 0.10 and about 1.0 centimeters, including every hundredth centimeter there between. More preferably, the diameter of the hole is in the range of between about 0.2 and about 0.5 centimeters. It is most preferred that when the hole is circular that the diameter of the hole is about 0.3 centimeters.

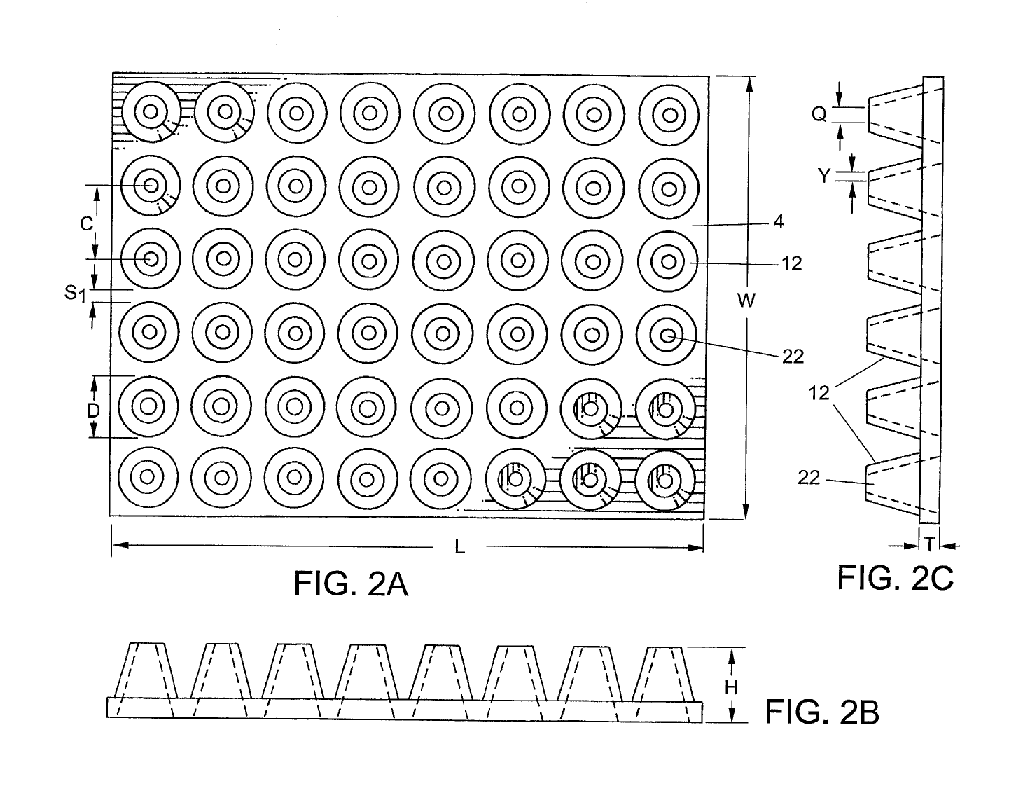

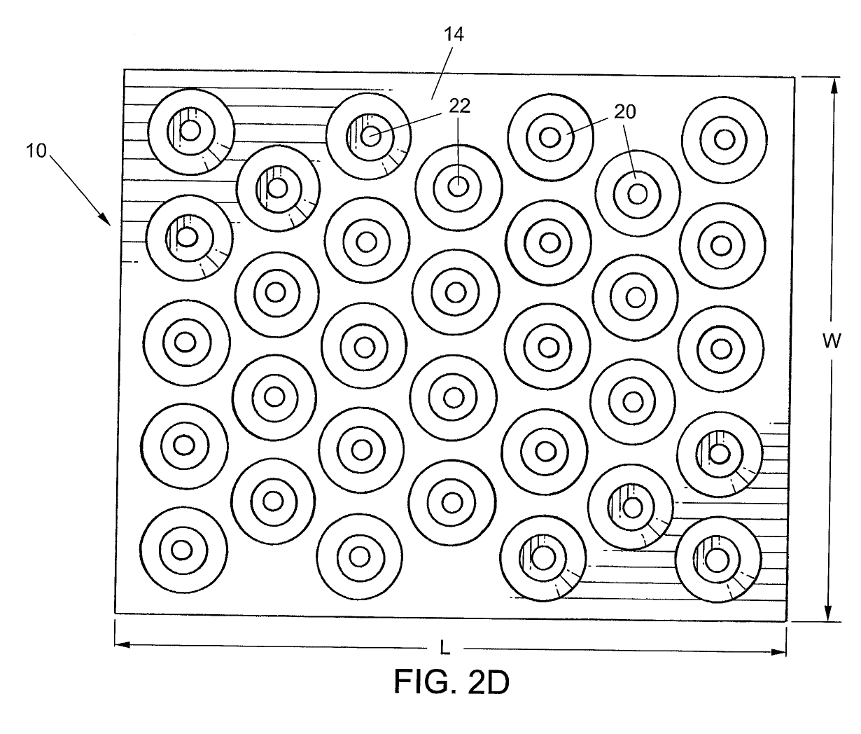

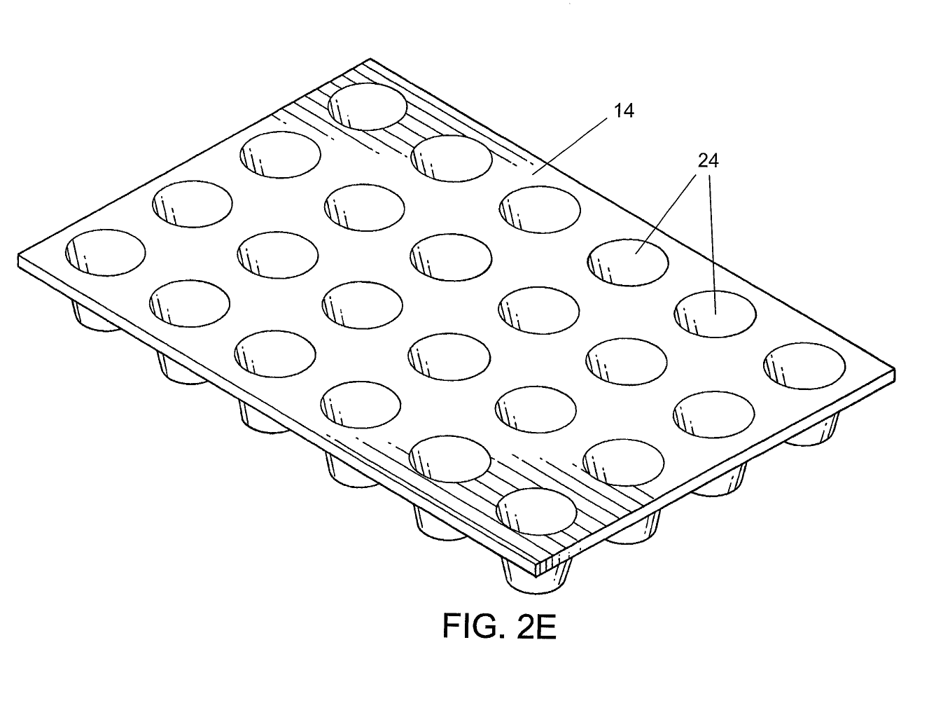

In FIG. 2a is shown a top view of a section of a headliner construct according to one form of the invention having a length dimension L and a width dimension W. In this figure, the absorption projections 12 are shown in a square array that is 8 absorption projections long and 6 absorption projections wide. However, the absorption projections 12 may also be in a staggered configuration as shown in FIG. 2d, which principle is equally applicable to cases when other geometric solids are employed in the stead of truncated cones, which truncated cones shown in the embodiment of FIG. 1. In embodiments in which the absorption projections of the invention are arranged in rows that are not staggered, as shown in FIG. 2a, the variable S₁ is used to refer to the distance between individual adjacent absorption projections from adjacent rows. It is preferred that this distance is between about 0.1 and about 2.0 centimeters, including every hundredth centimeter therebetween. It is more preferred that this distance is between about 0.5 and about 1.0 centimeters, including every hundredth centimeter therebetween, with about 0.75 centimeters being most preferable.

The shape of the portion of the absorption projection that contacts the base portion 14 is that of a circle as viewed from above when truncated cones are selected. Such circle represents the outer perimeter of the base of the cone at the point where it extends upwardly from the base portion 14. Each one in a plurality of such circles have a centerpoint, and the centerpoints of adsorption projections in adjacent rows are separated by a definite distance when the absorption projections of the invention are arranged in rows which are not staggered, as shown in FIG. 2a. The variable C is used to refer to the distance between the centerpoints of individual adjacent absorption projections from adjacent rows. It is preferred that this distance is between about 1.0 and about 4.0 centimeters, including every hundredth centimeter therebetween. It is more preferred that this distance is between about 1.5 and about 3.2 centimeters, including every hundredth centimeter therebetween, with about 2.0 centimeters being most preferable.

The shape of the portion of a given absorption projection which contacts the base portion 14 determines the amount of the surface area of the base portion which is to be occupied by the absorption projection. In the case where the shape of the portion of a given absorption projection which contacts the base portion 14 is circular, such absorption projection has a base diameter indicated by D in FIG. 2a. It is preferred that this diameter is between about 0.5 and about 3.0 centimeters, including every hundredth centimeter therebetween in the case of a circular absorption projection. It is more preferred that this diameter is between about 1.0 and about 2.0 centimeters, including every hundredth centimeter therebetween, with about 1.5 centimeters being most preferable.

In the present application “absorption projection density” means the number of absorption projections that occupy a base portion 14 according to the invention in terms of absorption projections per square centimeter. It is preferred that the absorption projection density is between about 0.05 and about 1.0 absorption projections per square centimeter, in the case of a circular absorption projection. It is more preferred that this density is between about 0.10 and about 0.50 absorption projections per square centimeter, with about 0.36 absorption projections per square centimeter being most preferable.

When truncated cones are selected, the cones will appear circular as viewed from above at both the point where the lower portion of the cone contacts the base portion 14 and the outer perimeter of the upper portion 20 of the truncated cone. It is preferred that the diameter of the perimeter of the upper portion 20 of the truncated cone is between about 0.50 and about 2.5 centimeters, including every hundredth centimeter therebetween in the case of a circular absorption projection. It is more preferred that this diameter is between about 0.75 and about 2.0 centimeters, including every hundredth centimeter therebetween, with about 1.0 centimeters being most preferable.

The base portion 14 may take on any shape required by the particular application in which a headliner according to the invention will be used. Thus, it is quite often the case that a headliner construct according to the invention will not exist in the form of a rectangular sheet with its absorption projections, but will rather take on the shape of the headspace it is intended to cover. In any event, the base portion of a construct according to the invention will have a definite thickness as represented by T in FIG. 2c. It is preferred that the thickness T is between about 0.10 and about 2.0 centimeters, including every hundredth centimeter therebetween. It is more preferred that the thickness T is between about 0.20 and about 1.75 centimeters, including every hundredth centimeter therebetween, with about 1.50 centimeters being most preferable.

Another variable in a headliner construct according to the invention is the thickness of the wall portion of the absorption projection as represented by Y in FIG. 2c. In the cases where the absorption projection is selected to exist in the shape of a cylinder or truncated cone, it is preferred that the thickness Y is between about 0.10 and about 1.0 centimeters, including every hundredth centimeter therebetween. It is more preferred that the thickness Y is between about 0.20 and about 0.75 centimeters, including every hundredth centimeter therebetween, with about 0.40 centimeters being most preferable.

During the manufacture of a headliner construct according to the invention, indentations are formed on the opposite side of the base portion from which the absorption projections protrude thus causing holes 24 to appear thereon, as shown in FIG. 2e.

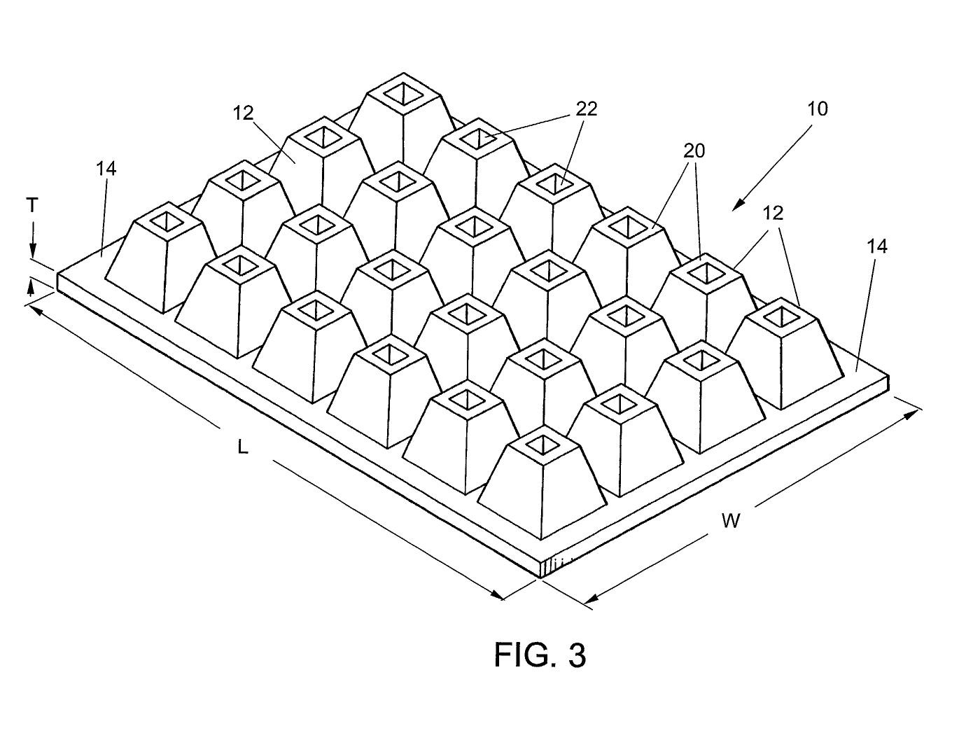

FIG. 3 shows a perspective view of a section of a headliner construct according to an alternative embodiment of the invention in which the absorption projections are truncated pyramids. In FIG. 3, there is a base portion 14, from whose surface project outwardly a plurality of absorption projections 12 each having an upper surface 20 having holes 22 disposed therethrough. The construct has a length dimension L a width dimension W, and a thickness dimension T.

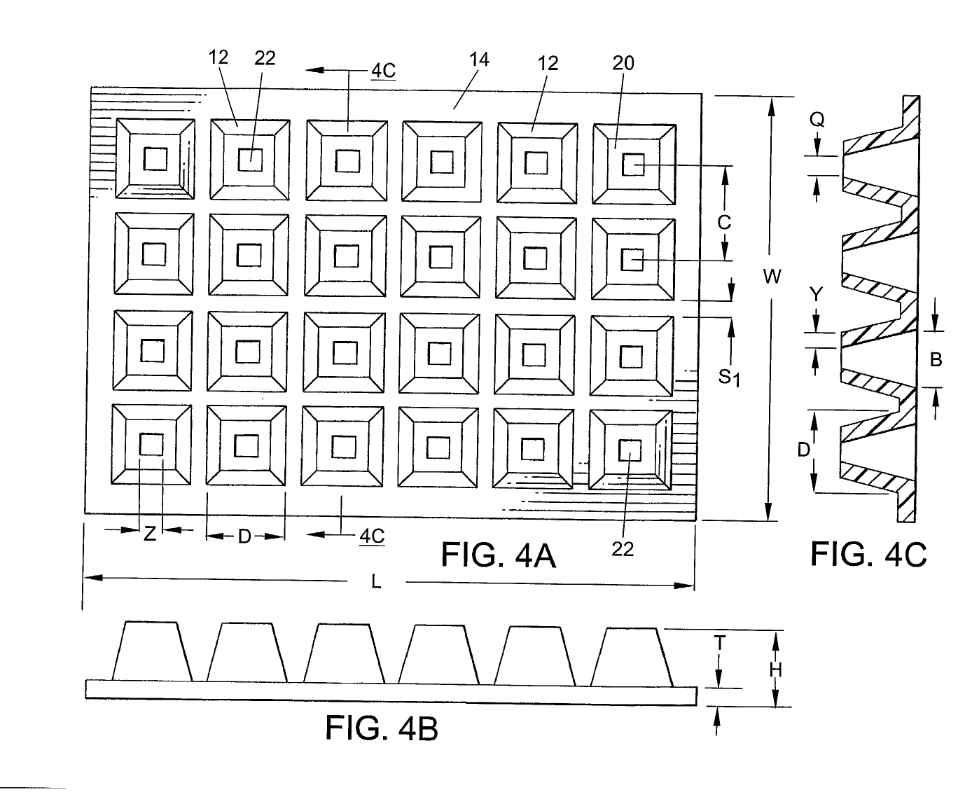

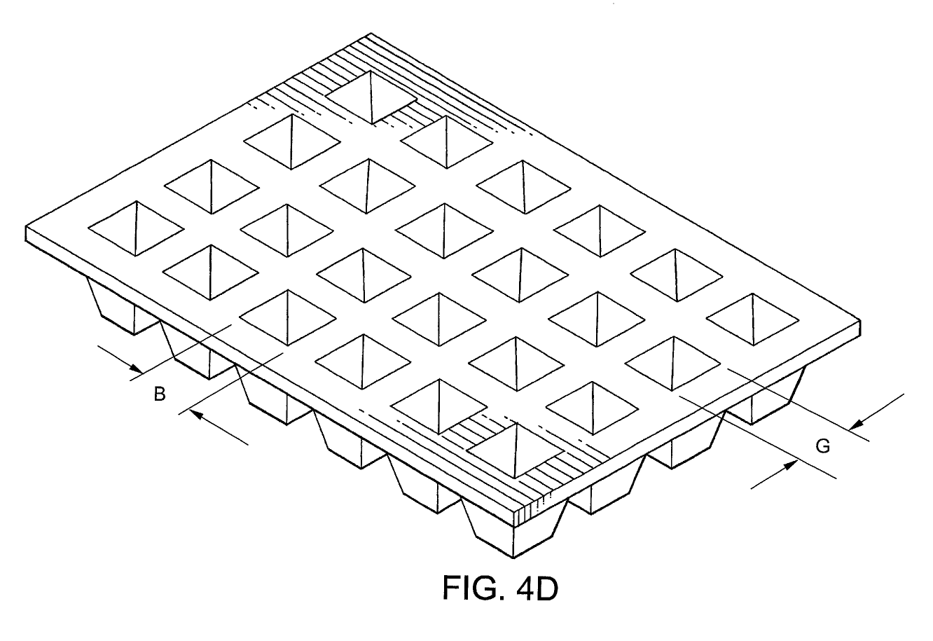

In FIG. 4a is shown a top view of a section of a headliner construct according to one form of the invention having a length dimension L and a width dimension W. In this figure, the absorption projections 12 are shown in a square array which is 6 absorption projections long and 4 absorption projections wide. However, the absorption projections 12 may also be in a staggered configuration as was shown in the case of the truncated cones in FIG. 2d. In embodiments in which the absorption projections of the invention are arranged in rows that are not staggered, as shown in FIG. 4a, the variable S₁ is used to refer to the distance between individual adjacent absorption projections from adjacent rows. It is preferred that this distance is between about 0.10 and about 2.0 centimeters, including every hundredth centimeter therebetween. It is more preferred that this distance is between about 0.20 and about 1.5 centimeters, including every hundredth centimeter therebetween, with about 0.75 centimeters being most preferable.

The shape of the portion of the absorption projection that contacts the base portion 14 is that of a square as viewed from above when truncated pyramids are selected. Such square represents the outer perimeter of the base of the pyramid at the point where it extends upwardly from the base portion 14. Each one in a plurality of such squares have a centerpoint, and the centerpoints of adsorption projections in adjacent rows are separated by a definite distance when the absorption projections of the invention are arranged in rows which are not staggered, as shown in FIG. 3a. The variable C is used to refer to the distance between the centerpoints of individual adjacent absorption projections from adjacent rows. It is preferred that this distance is between about 0.10 and about 1.0 centimeters, including every hundredth centimeter therebetween. It is more preferred that this distance is between about 0.20 and about 0.50 centimeters, including every hundredth centimeter therebetween, with about 0.30 centimeters being most preferable.

The shape of the portion of a given absorption projection which contacts the base portion 14 determines the amount of the surface area of the base portion which is to be occupied by the absorption projection. In the case where the shape of the portion of a given absorption projection which contacts the base portion 14 is a square, such absorption projection has a base dimension indicated by D in FIG. 4a. It is preferred that this dimension is between about 0.20 and about 4.0 centimeters, including every hundredth centimeter therebetween in the case of a pyramidal absorption projection. It is more preferred that this dimension is between about 1.0 and about 3.0 centimeters, including every hundredth centimeter therebetween, with about 1.5 centimeters being most preferable.

In the case of pyramidal absorption projections, it is preferred that the absorption projection density is between about 0.1 and about 1.0 absorption projections per square centimeter. It is more preferred that this density is between about 0.20 and about 0.50 absorption projections per square centimeter, with about 0.37 absorption projections per square centimeter being most preferable.

When truncated pyramids are selected, the pyramids will appear as a square as viewed from above at both the point where the lower portion of the pyramid contacts the base portion 14, and at the outer perimeter of the upper portion 20 of the truncated pyramids. It is preferred that the length dimension of the perimeter of the upper portion 20 of the truncated pyramid is between about 0.2 and about 3.5 centimeters, including every hundredth centimeter therebetween in the case of a circular absorption projection. It is more preferred that this dimension is between about 0.5 and about 2.5 centimeters, including every hundredth centimeter therebetween, with about 1.5 centimeters being most preferable. In the case when the upper surface 20 of a truncated pyramid exists in the shape of a rectangle, these same preferred dimensions are applicable, and refer to the length dimension of such rectangle.

The base portion 14 may take on any shape required by the particular application in which a headliner according to the invention is will be used. Thus, it is quite often the case that a headliner construct according to the invention will not exist in the form of a rectangular sheet with its absorption projections, but will rather take on the shape of the headspace it is intended to cover. In any event, the base portion of a construct according to this embodiment of invention will have a definite thickness as represented by T in FIG. 4b. It is preferred that the thickness T is between about 0.10 and about 2.0 centimeters, including every hundredth centimeter therebetween. It is more preferred that the thickness T is between about 0.20 and about 1.75 centimeters, including every hundredth centimeter therebetween, with about 1.50 centimeters being most preferable.

A construct according to the invention in which square pyramids are employed as the absorption projections also has an overall height measurement, as represented by H in FIG. 4b. It is preferred that the height H is between about 0.50 and about 3.00 centimeters, including every hundredth centimeter therebetween. It is more preferred that the height H is between about 1.00 and about 2.50 centimeters, including every hundredth centimeter therebetween, with about 2.00 centimeters being most preferable.

A construct according to the invention in which pyramids are employed as the absorption projections also has as one of its variables of construction the dimensions of the length B and width G of the holes in the planar base portion when viewed from the underside, as shown in FIG. 4d. In the case where B and G are equal, the absorption projection exists in the shape of a square pyramid. It is preferred that the width G is between about 0.50 and about 3.00 centimeters, including every hundredth centimeter therebetween. It is more preferred that the width G is between about 0.75 and about 2.00 centimeters, including every hundredth centimeter therebetween, with about 1.75 centimeters being most preferable.

It is preferred that the length B is between about 0.50 and about 3.00 centimeters, including every hundredth centimeter therebetween. It is more preferred that the length B is between about 0.75 and about 2.00 centimeters, including every hundredth centimeter therebetween, with about 1.75 centimeters being most preferable.

Another variable in a headliner construct according to the invention is the size of the hole 22 at the top flat surface portion 20. In cases where the hole is not circular as in the cases where an absorption projection having a pyramidal or rectangular solid is selected, the hole will be either be square or rectangular in dimension, although other shapes are contemplated herein, such as ellipses, ovals, rhombuses, hexagons, trapezoids, etc. When the hole is a square polygon such as a square or rectangle, the dimensions of length Z and width Q from FIGS. 4a and 4c serve to define the dimensions of the hole 22 at the top surface 20 of the absorption projections. In the case where Z and Q are equal, the hole at the top portion 20 of the absorption projection exists in the shape of a square. It is preferred that the length Z is between 0.10 and 1.00 centimeters, including every hundredth centimeter therebetween. It is more preferred that the length Z is between about 0.20 and about 0.75 centimeters, including every hundredth centimeter therebetween, with about 0.30 centimeters being most preferable. It is preferred that the width Q is between about 0.10 and 1.00 centimeters, including every hundredth centimeter therebetween. It is more preferred that the width Q is between about 0.20 and about 0.75 centimeters, including every hundredth centimeter therebetween, with about 0.30 centimeters being most preferable.

A further variable in a headliner construct according to the invention is the thickness of the wall portion of the absorption projection as represented by Y in FIG. 4c. In the cases where the absorption projection is selected to exist in the shape of a pyramid, it is preferred that the thickness Y is between about 0.10 and about 1.00 centimeters, including every hundredth centimeter therebetween. It is more preferred that the thickness Y is between about 0.20 and about 0.75 centimeters, including every hundredth centimeter therebetween, with about 0.40 centimeters being most preferable.

Although the embodiments herein depicted in the various drawings show a construct according to the invention having absorption projections of uniform shape and dimension, the present invention contemplates headliner constructs comprising an assortment of absorption projections having different geometrical shapes. For example, a headliner construct according to the invention may include a row of truncated cones adjacent to a row truncated pyramids. Alternatively, headliner construct according to the invention may include a row of rectangular solids adjacent to a row truncated pyramids or a row of truncated cones. The various absorption projections selected may be present in a mixed array or arranged in a regularly repeating pattern.

One non-delimitive example is shown in FIG. 5A, in which a preferred embodiment of the invention is depicted having a headliner construct comprising two differently sized solids having different length dimensions arranged in a regular array. This embodiment utilizes projections 26 and 28 that are essentially quadrilateral in shape such that they are either substantially cubes or rectangles. In the case of substantially rectangular projections 26 and 28 the relative ratio of the lengths of the sides can be varied as necessary to maximize the impact protection and to allow for finished headliner to be fitted to the appropriate shape for installation. As shown in FIG. 5A, the size of all of the projections 26 and 28 need not be identical. The number and width of channels 30 and 32 are also a variable in the construction of this embodiment of the present invention. The width of both channels 30 and 32 is typically about 1.3 centimeters. The thickness and width of the projections may be varied as desired to meet the design requirements for a specific headliner application, with the longest legs of the rectangles typically ranging from about 0.2 to 2.0 centimeters.

The height of the projections 34 that is shown in FIGS. 5C and 5D is also variable depending on the application for which the finished headliner is to be used. The thickness of the foam 36 that forms the headliner is typically about 30 mm thick, but can be varied as desired.

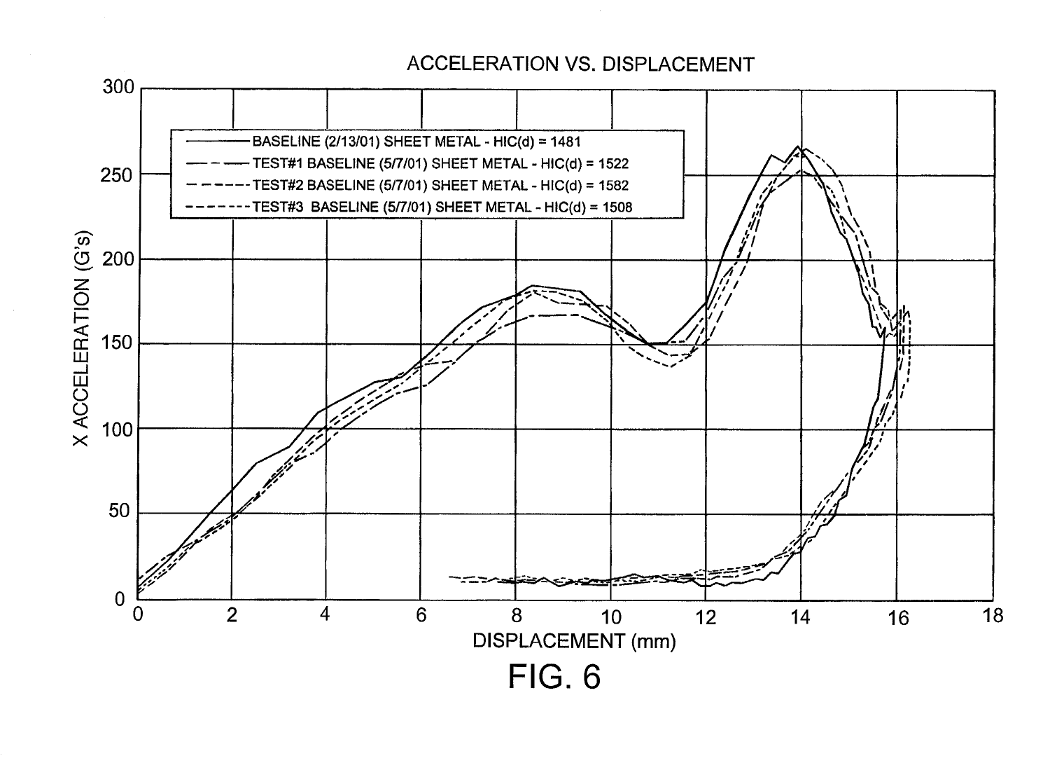

The graph in FIG. 6 depicts the beneficial results obtained with the present invention. The axes of the graph are acceleration, in units of multiples of the force of gravity (G's) and displacement, measured in millimeters. The baseline case, I, which does not include the advantages of the present invention, has an HIC (d) value of 1600. Plot II is data obtained for a 25 mm thickness of GECET® foam having a density of 3.0 pounds per cubic foot (pcf) in a pattern similar to that depicted in FIG. 5. where the approximate width and length of the top of projections 26 are about 23 mm and 10 mm respectively, and the approximate width and length of the top of projections 28 are about 60 mm and 10 mm respectively. The width of the channels 30 and 32 is approximately 10 mm.

Plots III, IV and V are for similarly patterned GECET® foam to that used in plot II, wherein the thicknesses 36 and densities are 25 mm and 2.5 pef (III), 30 mm and 2.5 pcf (IV), and 35 mm and 3.0 pcf (V). The HIC(d) values for the four samples are 890(II), 874 (III), 717 (IV) and 622(V), which are well below the value of 1000 mandated by FMVSS 201.

The preferred materials of construction of a headliner according to the present invention include all materials known in the prior art which have been used as cushioning materials in headliners used in motor vehicles and others, including foams such as polyolefin foams such as polyethylene foams, polypropylene foams, polystyrene foams, polyurethane foams, polyurea foams, etc. Such materials include without limitation various foamed materials such as: polyurethanes, foamed polystyrenes, foamed polyolefins such as polypropylene and polyethylene, including copolymers thereof. Especially preferred materials are the resins known as GECET® resins ARCEL® resins and RMER® resins. Any foamed material is suitable for providing a construct according to the invention.

A finished headliner construct according to the invention, includes indents on the opposite side of the base portion from which the absorption projections protrude which appear in the form of holes 24, as is shown in FIGS. 2e and 4d.

In order to produce a headliner construct according to the present invention one may use a thermoforming process using a sheet of foam as a starting material as such thermoforming is known to those skilled in the art. In cases where truncated cones, pyramids, cylinders, etc. are selected, a die may be used to cut the holes in the formed sheets either prior to or after thermoforming. Alternatively, the foam may be produced by introducing the pre-set foam composition into a mold, as such is known to those skilled in the art.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims that follow.

What is claimed is:

1. A construct useful as a headliner in a motorized vehicle comprising:
a) a substantially-planar first base portion having an upper surface and a lower surface;
b) one or more absorption projections disposed on the upper surface of the base portion, the absorption projections each being shaped in the form of a geometric solid having an axis, and wherein the absorption projections include a second base portion and a topmost portion, and which absorption projections extend from the upper surface such that their axes are oriented substantially perpendicularly to the plane of the base portion.

2. The construct recited in claim 1, wherein the construct further comprises a foam material chosen from the group consisting of polyurethanes, foamed polystyrenes, foamed poly alpha-olefins, and copolymers and mixtures of any of the above.

3. The construct recited in claim 2, wherein the foam material comprises GECET®, ARCEL® or RMER ® resin, or a mixture thereof.

4. The construct recited in claim 1, wherein the absorption projections further comprise a hollow interior portion.

5. The construct recited in claim 4, wherein the hollow interior portion extends along the axes of said absorption projections.

6. The construct recited in claim 4, wherein the geometric solid is selected from the group consisting of: cones, truncated cones, pyramids, truncated pyramids, rectangular solids, cubes, spheres, cylinders, spheroids, ellipses, truncated ellipses, rhombohedral solids, truncated rhombohedral solids.

7. The construct recited in claim 6, wherein the absorption projections include a hole disposed through their topmost portions that extend into the hollow interior portion of the absorption projections.

8. The construct recited in claim 7, wherein the first base portion includes one or more holes disposed through its surface beneath each of the absorption projections, such that the holes extend into the hollow interior portion of the absorption projections, thus making each of the absorption projections hollow and having an outer wall portion.

9. The construct recited in claim 8, wherein the absorption projections are selected from the group consisting of square pyramids, rectangular pyramids, and truncated cones.

10. The construct recited in claim 9, wherein the plurality of absorption projections are arranged in rows side-by-side one another so that the absorption projections of a given row are staggered with respect to those in a adjacent rows.

11. The construct recited in claim 9, wherein the absorption projections are arranged in rows side-by-side one another so that the absorption projections of a given row are not staggered with respect to those in adjacent rows.

12. The construct recited in claim 9, wherein the thickness of the outer wall portion is any thickness any thickness in the range of between about 0.10 centimeters and about 1.00 centimeters, including every hundredth centimeter therebetween.

13. The construct recited in claim 10, wherein the closest distance between the second base portion of any two given absorption projections is in the range of between about 0.10 centimeters and about 1.00 centimeters, including every hundredth centimeter therebetween.

14. The construct recited in claim 11, wherein the closest distance between the second base portions of any two given absorption projections within the same row is in the range of between about 0.10 centimeters and about 1.00 centimeters, including every hundredth centimeter therebetween.

15. The construct recited in claim 11, wherein the closest distance between the second base portions of any two given absorption projections from adjacent rows is in the range of between about 0.10 centimeters and about 1.00 centimeters, including every hundredth centimeter therebetween.

16. The construct recited in claim 9, wherein the absorption projection density is any value in the range between about 0.05 absorption projections per square centimeter and about 1.50 absorption projections per square centimeter, including every hundredth of a projection therebetween.

17. The construct recited in claim 1, wherein the thickness of the first base portion is any value in the range of between about 0.10 centimeters and about 2.00 centimeters, including every hundredth centimeter therebetween.

18. The construct recited in claim 6, wherein the geometric solid is a truncated cone, and wherein the topmost portion takes on the shape of a circle.

19. The construct recited in claim 18, wherein the diameter of the circle is in the range of about 0.20 centimeters to about 2.00 centimeters.

20. The construct recited in claim 6, wherein the geometric solid is a truncated square pyramid, and wherein the topmost portion takes on the shape of a square.

21. The construct recited in claim 20, wherein the length of one of the legs of the square is in the range of about 0.50 centimeters to 2.50 centimeters, including every hundredth centimeter therebetween.

22. The construct recited in claim 6, wherein the geometric solid is a truncated pyramid, and wherein the topmost portion takes on the shape of a rectangle.

23. The construct recited in claim 22, wherein the length of the longest of the legs of the rectangle is in the range of about 0.20 centimeters to about 2.00 centimeters, including every hundredth centimeter therebetween.

24. The construct recited in claim 6, wherein the geometric solid is a rectangle, and wherein the topmost portion is also a rectangle.

25. The construct recited in claim 24, wherein the length of the longest of the legs of the rectangle is in the range of about 0.20 centimeters to about 2.00 centimeters, including every hundredth centimeter therebetween.

26. The construct recited in claim 24, wherein the rectangles further comprise two or more groups, and each group comprises rectangles of different dimensions from the other groups.

27. The construct recited in claim 24, wherein the shortest distance between the axes of any two given absorption projections is in the range of between about 1.00 centimeter and about 4.50 centimeters, including every hundredth centimeter therebetween.

28. The construct recited in claim 4, wherein the distance between the topmost portion of the absorption projection and the lower surface of the first base portion is in the range of between about 1.00 centimeters and about 5.00 centimeters, including every hundredth centimeter therebetween.

29. A method of forming a headliner for use in a motorized vehicle comprising the steps of:
providing a mold for a headliner further comprising a surface suitable for providing a substantially-planar first base portion having an upper surface and a lower surface, and one or more absorption projections disposed on the upper surface of the base portion, the absorption projections each being shaped in the form of a geometric solid having an axis, and wherein the absorption projections include a second base portion and a topmost portion, and which absorption projections extend from the upper surface such that their axes are oriented substantially perpendicularly to the plane of the base portion; and
molding a foam material with the mold.

30. The method recited in claim 29, wherein the foam material is chosen from the group consisting of polyurethanes, foamed polystyrenes, foamed poly alpha-olefins, and copolymers and mixtures of any of the above.

31. The method recited in claim 29, wherein the foam material comprises GECET®, ARCEL® or RMER® resin, or a mixture thereof.

32. A construct useful as a headliner in a motorized vehicle comprising:
a) a substantially-planar base portion having an upper surface and a lower surface;
b) a plurality of first absorption projections each shaped in the general form of a first geometric solid disposed on the upper surface of the base portion;
c) a plurality of second absorption projections each shaped in the form of a second geometric solid disposed on the upper surface of the base portion,
wherein each of the first absorption projections and the second absorption projections have an axis, and wherein the axes of at least one of either of the first absorption projections or the second absorption projections are oriented parallel to the plane of the first base portion.

33. A construct according to claim 32 wherein only one of the axes of said first absorption projections and said second absorption projections are oriented parallel to the plane of the base portion, and the axis of said first absorption projections or said second absorption projections which are not oriented parallel to the plane of said first base portion are oriented perpendicular to said plane.

34. A construct according to claim 32 wherein the axes of both of said first absorption projections and said second absorption projections are oriented parallel to said plane.

35. A construct according to claim 32 wherein the axes of both of said first absorption projections and said second absorption projections are oriented perpendicular to said plane.

36. A construct according to claim 32 wherein said first absorption projections are shaped in the form of a rectangular solid.

37. A construct according to claim 36 wherein said second absorption projections are shaped in the form of a rectangular solid.

38. The construct recited in claim 32, wherein the construct further comprises a foam material chosen from the group consisting of polyurethanes, foamed polystyrenes, foamed poly alpha-olefins, and copolymers and mixtures of any of the above.

39. The construct recited in claim 38, wherein the foam material comprises GECET®, ARCEL® or RMER® resin, or a mixture thereof.

40. The construct recited in claim 32, wherein at least one of said first or second absorption projections further comprise a hollow interior portion.

41. The construct recited in claim 32, wherein at least one of said first or second absorption projections further comprise a hollow interior portion and wherein the hollow interior portion extends along the axes of said absorption projections.
